(19) United States
(12) Patent Application Publication
(10) Pub. No.: US 2005/0106964 A1
(43) Pub. Date: May 19, 2005

(54) Reinforcement mesh for bituminous layers

(76) Inventor: Jurgen Kassner, Gescher (DE)

Correspondence Address: PATENT GROUP;CHOATE, HALL & STEWART, EXCHANGE PLACE, 53 STATE STREET, BOSTON, MA, 02109, US

(21) Appl. No.: 10/507,085

(22) PCT Filed: Mar. 11, 2003
(86) PCT No.: PCT/EP03/02458

(30) Foreign Application Priority Data
Mar. 22, 2002 (DE) 10213057.4

(51) Int. Cl. B32B 27/04; B32B 5/02; B32B 27/12; B32B 11/02

(52) U.S. Cl. 442/48; 442/43; 442/58

(57) ABSTRACT

The invention relates to reinforcement mesh for bituminous layers, in particular for bitumen-containing carriageway coatings, with crossed strands of synthetic material. The aim of the invention is to produce a reinforcing mesh which can take extreme forces introduced into a bituminous layer and is elastically deformable. Said aim is achieved whereby the strands are made from a synthetic material with a ductile yield of between 3% and 8%, preferably between 5% and 6%.

The present invention relates to a reinforcement grid for bituminous layers, in particular bitumen-containing road surfaces, having crossed strands of synthetic material.

Bitumen-containing layers, in particular asphalt, have long proven suitable for producing the surface layers on areas that are to carry traffic, e.g., the surface of a street or an airport takeoff/landing strip or an airport tarmac. Asphalt layers have a high resistance to the mechanical stresses on a road surface in the usual temperature ranges. As a rule, the asphalt mixture is to be adapted to the temperatures occurring at the site of the road surface. An asphalt surface provides good traction for conventional vehicle tires made of rubber because of its very high friction coefficient. Due to its good deformability when hot, asphalt surfaces may be produced with minimal waviness so that they offer optimum driving comfort for the vehicle tires.

However, asphalt surfaces have the disadvantage that they have low elastic deformability. Even at low stresses due to mechanical loads or temperature fluctuations, the bituminous material of the asphalt surface begins to flow and the asphalt surface becomes plastic and thus permanently deformed.

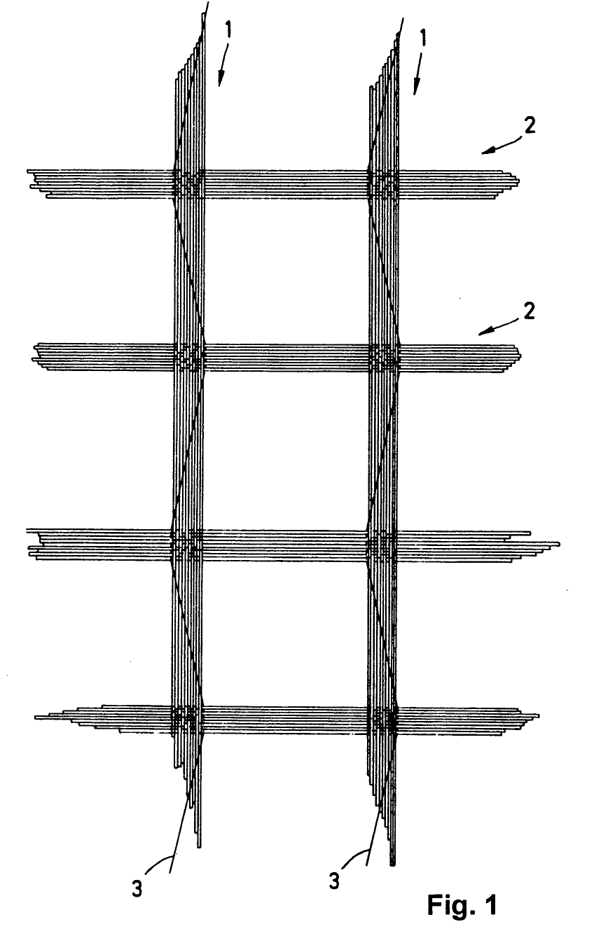

To increase the resistance of an asphalt surface to stresses and to improve its elastic properties while retaining its positive properties, reinforcement grids made of synthetic materials have been used for several decades. Such reinforcement grids are made of heavy-duty synthetic yarns of a polymer material, for example, in particular polyesters. These yarns are woven into a grid with mesh openings several centimeters in size. The groups or strands of warp and weft threads forming the grid are held together by leno threads. Such a reinforcement grid is disclosed in the publication DE 20 00 937 A1. To prevent the reinforcement grid from forming a separating layer for the bituminous layer, the grid is provided with large mesh openings. Coarse-grained components of the asphalt surface may protrude through the large openings in the grid, which achieves effective interlocking with the asphalt material of the road surface and thus yields effective reinforcement of the bitumen-containing layer over the entire area. A reinforcement grid according to DE 20 00 937 A1 is illustrated in the accompanying drawing in FIG. 1.

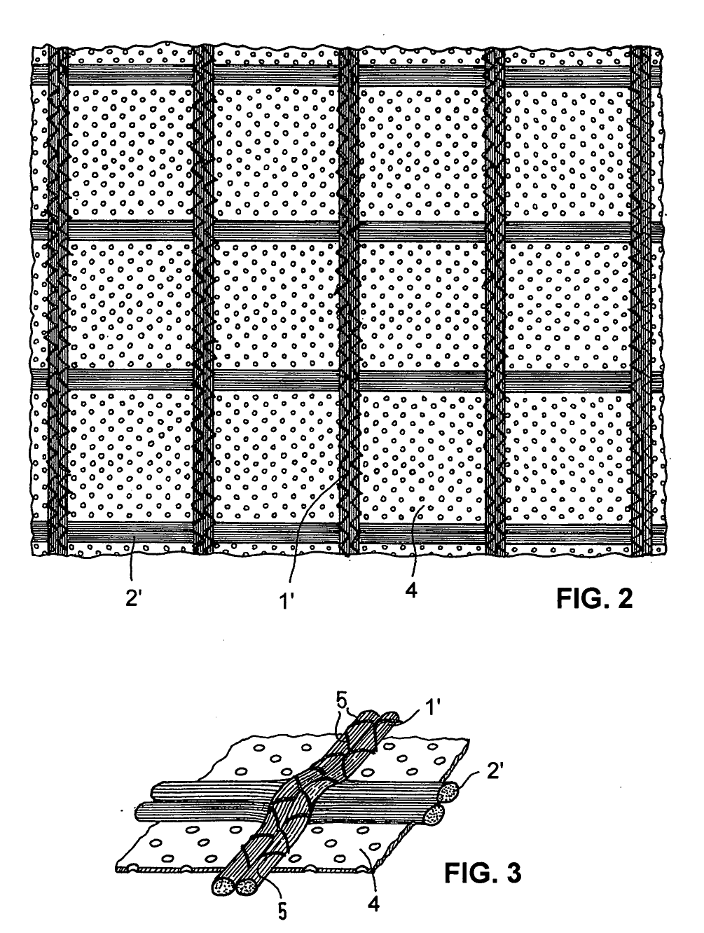

To achieve good adhesion to the bitumen layer, the reinforcement grid is usually coated with an adhesive having an affinity for bitumen. Alternative embodiments of such reinforcement grids additionally have a textile layer which fills the meshes and is made up of thin strips of material or a nonwoven fabric, for example. A reinforcement grid provided with a nonwoven layer is disclosed in DE 196 52 584 A1 and is illustrated in the accompanying drawing in FIGS. 2 and 3. This mesh-filling textile layer is also preferably coated with a bituminous adhesive. In the embodiments according to FIGS. 2 and 3, it may also have air holes which allow the passage of trapped air and adhesive during the installation of the reinforcement grid. For other applications, the reinforcement grid has an underlayment of a thick, bitumen-impregnated nonwoven material.

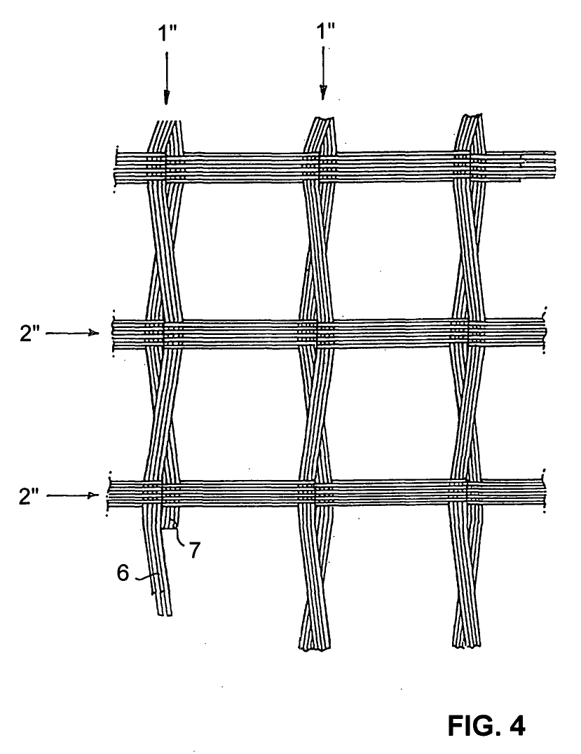

To secure the intersecting strands of threads of the reinforcement grid, the warp thread strands may also be divided into two warp thread groups, the first warp thread group crossing the second warp thread group of the same warp thread strand per mesh in the manner of a half-twist. Such a grid is the object of DE 199 62 441 A1 and is illustrated in accompanying FIG. 4.

As an alternative to the known textile grids having woven strands or strands joined together by a stitching or knitting technique, thin-layer plastic mats are also produced from polymer plastics, having mutually perpendicular strands that form meshes with an opening width of several centimeters. These grid mats are preferably also made of polyester. Other plastics that are conventional in construction technology, such as polyethylene or polypropylene, have not proven successful as asphalt reinforcement because of their temperature susceptibility.

A considerable disadvantage of the known reinforcement grids is their non-steady stress-strain behavior. When tensile stresses are applied, polyester initially has a force uptake which increases approximately in proportion to the strain but then essentially stagnates after a relative strain of 1% to 2%. FIG. 4 schematically shows a stress-strain diagram of a typical polyester material. In the range between 2% and 5% strain of the polyester material, no significant increase in stress in the polyester material is observed and thus there is no significant increase in the force uptake. A significant increase in stress occurs again only above approximately 5% of the material strain. It should be noted here that according to the stress-strain curve for bitumen shown with a dashed line in FIG. 4, the maximum stress uptake and thus the ductile yield value for bitumen occur at almost 5%. The reinforcement effect of a polyester grid therefore begins essentially only when the bitumen material has already reached the maximum of its extensibility and begins to crack. Cracks in the bitumen layer may cause permanent damage to the road surface.

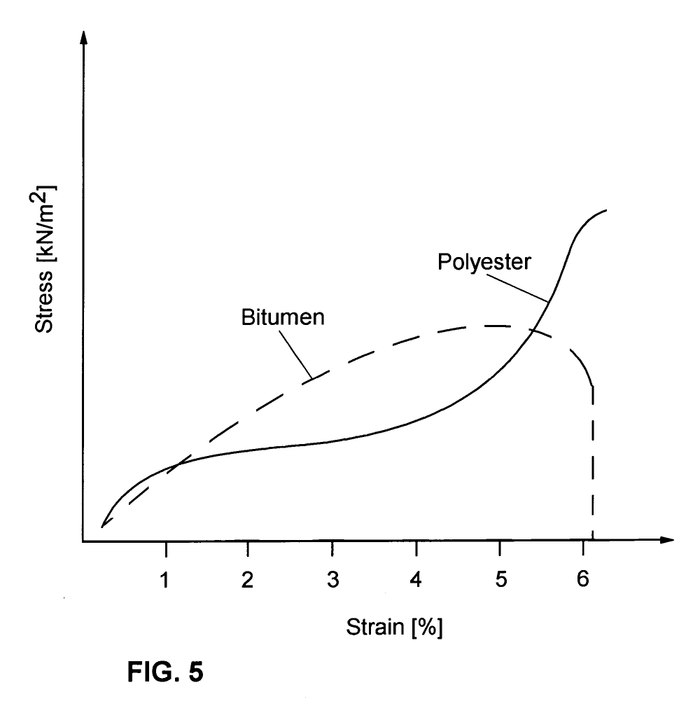

As an alternative, a reinforcement grid of fiberglass or fiberglass-reinforced plastic has been proposed in the past. Although fiberglass has a considerably higher force uptake capacity, it has almost no extensibility and is brittle. A stress-strain diagram for fiberglass is shown schematically in FIG. 5, a dashed line showing the stress-strain curve for a bituminous material.

Fiberglass is unable to absorb shearing forces in particular. Even during the installation of a bituminous layer, a reinforcement grid of fiberglass may be damaged in the bitumen layer. Shearing forces occur due to the compaction of the bitumen layer, possibly overloading the fiberglass and causing breakage. When a bitumen layer is applied to a road surface of concrete slabs in particular, high shearing forces may occur during installation as well as after installation, e.g., due to thermal strains, and result in destruction of the fiberglass. In addition, fiberglass has a low alkali stability, which has a negative effect on its suitability for an airport tarmac and runway, because alkali-based substances may reach the grid here due to the use of deicing agents, which may penetrate into hairline cracks in the road surface and may damage the grid in the case of fiberglass.

The object of the present invention is to create a reinforcement grid capable of absorbing high forces applied to a bituminous layer and having good elastic deformability.

This object is achieved according to the present invention by the fact that the strands of synthetic material have a ductile yield between 3% and 8%.

The ductile yield of the synthetic material of the strands is preferably between 5% and 6%, which is thus exactly within the range of the ductile yield of a bitumen-containing road layer.

Selecting a synthetic material having essentially the same maximum strain as the layer to be reinforced ensures that the reinforced layer and the reinforcement grid will cooperate optimally. Both have the same range of maximum force uptake before a break in the material occurs. Both materials are extensible in a certain range, preferably by up to 5% or 6%, before the stress absorbed by the materials drops and cracks appear in the reinforced layer. This ensures not only that the reinforced layer will be able to absorb high forces occurring on it but also that the bituminous material together with the reinforcement is deformable within their strain range without resulting in damage to the bitumen layer or the reinforcement. In this way, the shearing forces that occur during installation and even after installation due to loads and temperature fluctuations may be readily absorbed via deformation of the grid without causing any damage.

In one embodiment, the synthetic strands of the grid have a steady force uptake, i.e., an essentially steady stress-strain diagram. In particular, the absorbed stress value, i.e. the force absorbed by a strand having a given cross section is essentially proportional to the value of the strain. Although it is known that synthetic materials usually do not have an exactly proportional stress-strain curve (unlike metallic materials, for example), a largely steady and almost proportional stress-strain curve may be achieved by selecting a suitable synthetic material. On the one hand, this stress-strain curve will not have the range of increasing strain without an increase in the stress uptake that occurs with polyester, and on the other hand, it will not have the brittle properties of fiberglass.

Said strength properties may be achieved by producing the intersecting strands of the reinforcement grid from a high-strength polyvinyl alcohol. Polyvinyl alcohol (PVA) is a plastic with which the mechanical properties described above, i.e., essentially a steady, almost proportional stress-strain curve and a ductile yield in the range between 5% and 6%, are achievable. The ductile yield corresponds essentially to the ductile yield of the reinforced bitumen layer.

Furthermore, PVA has a high chemical stability and is not attacked or damaged by ureas or by saline solutions which are formed when deicing roads. PVA is additionally independent of moisture, i.e., it has the same strength whether wet or dry. For example fiberglass does not have such a moisture independence. Fiberglass loses a great deal of strength due to moisture, in particular when the reinforced road surface develops hairline cracks through which water may reach the reinforcement grid.

PVA has a strength modulus two to three times greater than that of a polyester material, so that much thinner strands of PVA may be used to achieve the same reinforcement.

In comparison with glass grids, PVA is much less brittle and may absorb much higher shear and buckling forces. The danger of a PVA grid being destroyed during or after installation is thus much lower than the damage or destruction of a grid made of fiberglass. Because of the similar ductile yield, PVA is usually damaged only when the reinforced bitumen layer is also damaged.

Furthermore, PVA grid has a much higher dynamic load rating than grid made of fiberglass. PVA may be processed directly to form a reinforcement grid. Preferably, however, it is processed as a yarn to form a high-strength textile grid, in particular by weaving.

Like the known polyester grid, the grid of polyvinyl alcohol (PVA) may be coated with an adhesive having an affinity for bitumen. Furthermore, it is preferably provided with a lightweight membrane, e.g., a thin nonwoven.

Although in practice the use of PVA-coated reinforcement grid for reinforcing layers of soil is already known from the applicant's product, which is distributed under the brand name Fortrac M, the good correspondence between the stress-strain curve of a PVA grid and the stress-strain curve of the reinforced bitumen layer has not yet been achieved for an asphalt reinforcement grid.

Additional aspects of the present invention are explained in greater detail below with reference to the accompanying drawing.

FIG. 1 shows a top view of a first embodiment of a reinforcement grid for bitumen-containing road surfaces.

FIG. 2 shows a top view, and

FIG. 3 shows a perspective view of a second embodiment of a reinforcement grid for bitumen-containing road surfaces.

FIG. 4 shows a top view of another embodiment of a reinforcement grid which may be used for reinforcing road surfaces.

FIG. 5 shows a schematic stress-strain diagram for polyester and for a bitumen layer.

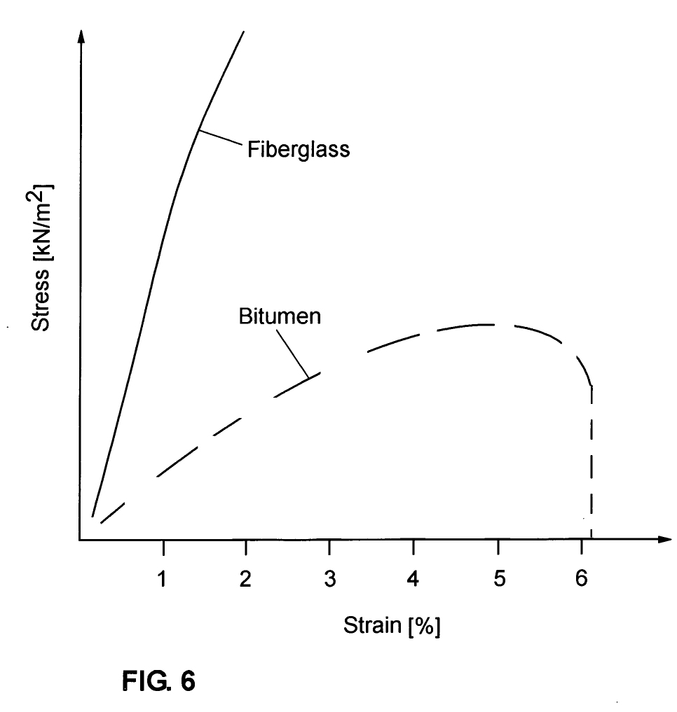

FIG. 6 shows a schematic stress-strain diagram for fiberglass and for a bitumen layer.

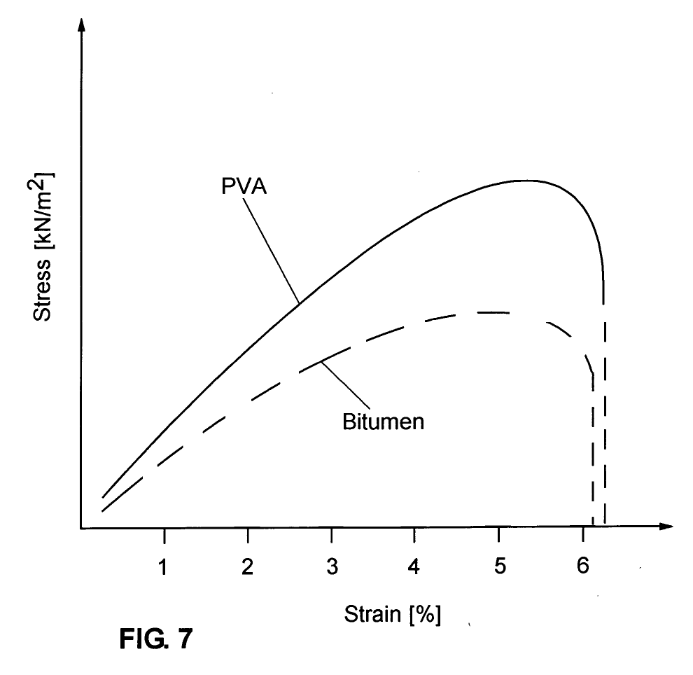

FIG. 7 shows a schematic stress-strain diagram for polyvinyl alcohol and for a bitumen layer.

The reinforcement grids discernible in FIGS. 1 through 4 have already been explained in detail in conjunction with the description of the related art. They have warp thread strands 1,1′,1″ running parallel to one another at regular intervals. Warp thread strands 1,1′,1″ are formed by multiple threads in the textile grids shown here, and according to the related art, they are made of polyester or fiberglass. Weft thread strands 2,2′,2″ which may also be made of polyester or fiberglass according to the related art extend perpendicular to the warp thread strands 1,1′,1″ and run at regular intervals and parallel to one another.

Warp thread strands 1,1′,1″ are joined to weft thread strands 2,2′,2″ at the points of intersection. In the first embodiment (see FIG. 1), the connection is obtained by means of a leno thread 3, which is guided over a warp thread strand 1 and runs alternately along the right and left sides of warp thread strand 1 under weft thread strand 2. The grid fabric formed by warp thread strands 1 and weft thread strands 2 is then coated with a bitumen-containing material which promotes good bonding between the bitumen layer to be reinforced and the grid and which also secures the intersecting warp and weft threads to one another.

According to the present invention, warp thread strands 1 and weft thread strands 2 may be made of polyvinyl alcohol, so that they have a largely steady stress-strain curve and have a ductile yield of approximately 5% to 6%.

FIGS. 2 and 3 show a reinforcement grid in which warp thread strands 1′ and weft thread strands 2′ are placed on a thin nonwoven backing 4 on a raschel warp knitting machine so that they intersect. In the raschel technique, warp threads 1′ are bonded to nonwoven backing 4 by a binding thread 5. At the points of intersection of warp threads 1′ with weft threads 2′, binding threads 5 also bind warp threads 1′ to weft threads 2′. In the present case, warp threads 1′ and weft threads 2′ are coated jointly with the nonwoven with an adhesive having an affinity for bitumen. According to DE 196 52 584 A1 by the present applicant in which such a grid is described, the use of PVA is already mentioned. However, there is no mention there of any adjustment of the stress-strain behavior of the strands of the grid to the stress-strain behavior of the bitumen layer according to the present invention.

FIG. 4 shows another embodiment of an open grid mat, which shows a textile grid according to DE 199 62 441 A1 mentioned above. Warp thread strands 1″ here are also divided into two warp thread groups 6, 7, first warp thread group 6 intersecting second warp thread group 7 of the same warp thread strand 1″ per mesh in the manner of a half-twist.

FIGS. 5, 6 and 7 show clearly the advantageous stress-strain curve of a PVA grid according to the present invention in comparison with the known polyester and glass grids.

FIG. 5 shows that a polyester thread hardly undergoes any increase in internal tensile stress over an essential segment in the range between 2% strain and 5% strain. In other words, in this strain range the uptake of force by the reinforcement grid does not increase significantly. Only above 5% does the force absorbed by the polyester reinforcement grid increase. However, the ductile yield of the bitumen layer to be reinforced is also in this range, so that the occurrence of cracks in the bitumen layer must be expected quickly with the onset of the reinforcement effect.

A fiberglass grid has the stress-strain behavior shown in FIG. 6. Although it absorbs high forces, it is very brittle and breaks under a low strain.

According to the present invention, a grid of PVA having a stress-strain curve that runs essentially in synchronization with that of the bitumen is selected for the reinforcement of a bitumen layer (see FIG. 7). It absorbs steadily increasing stresses in the range between 0% and 5% strain. The stress increases essentially in proportion to the strain of the PVA material. Since the reinforced bitumen layer has a similar stress-strain curve, the reinforced layer and the reinforcement grid may be loaded up to its ductile yield.

The design of a reinforcement grid according to the present invention is possible for all existing grid forms. This is true of the applicant's related art as depicted in FIGS. 1 through 4 as well as for grid mats not produced by a textile manufacturing technique.

List of Reference Numerals:

1,1′,1″ warp thread strand
2,2′,2″ weft thread strand
3 leno thread
4 nonwoven backing, backing layer
5 binding thread
6 warp thread group
7 warp thread group

1. A reinforcement grid for bituminous layers, comprising:
intersecting strands made of a synthetic material, wherein the strands made of a synthetic material have a ductile yield between 3% and 8%.

2. The reinforcement grid as recited in claim 1, wherein the ductile yield of the strands is between 5% and 6%.

3. The reinforcement grid as recited in claim 1 the force absorbed by the strands increases into the range of the ductile yield in proportion to the value of the strain of the strands.

4. The reinforcement grid as recited in claim 1, wherein the strands are made of a high-strength polyvinyl alcohol (PVA).

5. The reinforcement grid as recited in claim 1, wherein the strands are each made of at least one high-strength yarn.

6. The reinforcement grid as recited in claim 5, wherein the yarns are woven together.

7. The reinforcement grid as recited in claim 1, wherein two intersecting strands are bound together by binding threads.

8. The reinforcement grid as recited in claim 1, further comprising an adhesive coating having an affinity for bitumen.

9. The reinforcement grid as recited in one of the preceding claims claim 1, further comprising a backing layer.

10. The reinforcement grid according to claim 9, wherein said backing layer is a nonwoven backing layer impregnated with bitumen.

11. A reinforcement grid for a bituminous layer, comprising:
at least two intersecting strands including a synthetic material, wherein said at least two intersecting strands have a ductile yield that corresponds to a ductile yield of the bituminous layer.

12. The reinforcement grid as recited in claim 11, wherein an absorbed stress value of said at least two intersecting strands for a given cross section is approximately proportional to a value of strain in said strands.

13. The reinforcement grid as recited in claim 11, wherein the ductile yield of said at least two intersecting strands is approximately equal to the ductile yield of the bituminous layer.

14. The reinforcement grid as recited in claim 11, wherein said ductile yield of the at least two intersecting strands is between approximately 3% and approximately 8%.

15. The reinforcement grid as recited in claim 14, wherein said ductile yield of the at least two intersecting strands is between approximately 5% and approximately 6%.

16. The reinforcement grid as recited in claim 11, wherein each of said at least two intersecting strands includes at least one high strength yarn.

17. The reinforcement grid as recited in claim 11, wherein said at least two intersecting strands are bound together by binding threads.

18. The reinforcement grid as recited in claim 11, further comprising an adhesive coating having an affinity for bitumen.

19. A method for reinforcing a bituminous layer, comprising:
intersecting at least two strands within said bituminous layer, wherein said at least two strands include a synthetic material and wherein said at least two strands have a ductile yield that corresponds to a ductile yield of the bituminous layer.

20. The method of claim 19, wherein said ductile yield of the at least two strands is approximately equal to the ductile yield of the bituminous layer.

21. The method of claim 19, wherein said ductile yield is between approximately 3% and approximately 8%.

22. The method of claim 21, wherein said ductile yield of the at least two strands is between approximately 5% and approximately 6%.

23. The method of claim 19, further comprising weaving together said at least two strands.

24. The method of claim 19, further comprising binding together said at least two strands with binding threads.

25. The method of claim 19, further comprising coating said at least two strands with an adhesive coating having an affinity for bitumen.
